(19) United States
(12) Patent Application Publication
(10) Pub. No.: US 2015/0247088 A1
(43) Pub. Date: Sep. 3, 2015

(54) Liquid Crystal Medium of Liquid Crystal Panel

(71) Applicant: Shenzhen China Star Optoelectronics Technology Co. Ltd., Shenzhen (CN)

(72) Inventor: Chung-Ching Hsieh, Shenzhen (CN)

(73) Assignee: Shenzhen China Star Optoelectronics Technology Co. Ltd., Shenzhen (CN)

(21) Appl. No.: 13/806,017

(22) PCT Filed: Dec. 3, 2012
(86) PCT No.: PCT/CN12/85756

§ 371 Date: Dec. 20, 2012

(30) Foreign Application Priority Data
Nov. 21, 2012 (CN) 201210476767.2

(51) Int. Cl. C09K 19/30; C09K 19/54; C09K 19/12

(52) U.S. Cl. CPC C09K 19/3003; C09K 19/12; C09K 19/544; C09K 2019/3004

(57) ABSTRACT

The present invention discloses a liquid crystal medium of a liquid crystal panel. Liquid crystal compounds based on a tetracene derivative are bonded to alkenyl groups of liquid crystal molecules used as a diluting agent by doping the liquid crystal compounds based on the tetracene derivative into a liquid crystal mixture, for preventing a reaction between alkenyl groups of the liquid crystal molecules used as the diluting agent and polymerizable compounds, thereby inhibiting a bond between alkenyl groups of the liquid crystal molecules used as the diluting agent and the polymerizable compounds. The present invention is capable of improving the problem of image sticking produced via bonding the polymerizable compounds to alkenyl groups of the liquid crystal molecules used as the diluting agent.

### BACKGROUND OF THE INVENTION

1. Field of the Invention

The present invention relates to a liquid crystal layer for a liquid crystal panel, and more specifically to a liquid crystal medium of the liquid crystal panel that reduces image sticking.

2. Description of the Prior Art

In a process for manufacturing a liquid crystal display (LCD) panel, some residual polymerizable compounds inevitably exist in a liquid crystal layer of a patterned vertical alignment (PVA) mode LCD panel or a high vertical alignment (HVA) mode LCD panel. The residual polymerizable compounds are bonded to alkenyl groups of liquid crystal molecules used as a diluting agent. The residual polymerizable compounds are liquid crystal reactive monomers. After a long time operation, charged ions are formed by deterioration of charged polymerizable compounds, and then distribution of the charged polymerizable compounds and the charged ions is gradually changed, thereby leads to the deterioration of display quality of the LCD panel.

Specifically, during a long time operation, the charged polymerizable compounds and the charged ions within the liquid crystal layer may separate in accordance with polarity thereof. After the charged polymerizable compounds and the charged ions are separated in accordance with polarity thereof, a bias voltage applied to the liquid crystal layer is reduced by the charged polymerizable compounds and the charged ions. Accordingly, variation of the bias voltage applied to the liquid crystal layer occurs. The above phenomenon is so-call screen effect. Additionally, after the charged polymerizable compounds and the charged ions are separated in accordance with polarity thereof, a parasitic potential is generated within the LCD panel and a common voltage may vary (V-com shift phenomenon).

As mentioned above, since the charged polymerizable compounds and the charged ions within the liquid crystal layer lead to screen effect and variation of the common voltage, image sticking problem (or surface-type image sticking problem) may thus occur when the LCD panel is displayed. Accordingly, the display quality of the LCD panel is deteriorated. Therefore, there is a need to provide a liquid crystal compound doped in a liquid crystal mixture that can improve the problem of image sticking, so as to overcome the disadvantage in the prior art.

### SUMMARY OF THE INVENTION

An object of the present invention is to provide a liquid crystal medium of a liquid crystal panel. Liquid crystal compounds based on a tetracene derivative are bonded to alkenyl groups of liquid crystal molecules used as a diluting agent by doping the liquid crystal compounds based on the tetracene derivative into a liquid crystal mixture, for preventing a reaction between alkenyl groups of the liquid crystal molecules used as the diluting agent and polymerizable compounds, thereby inhibiting a bond between alkenyl groups of the liquid crystal molecules used as the diluting agent and the polymerizable compounds. The present invention is capable of improving the problem of image sticking produced via bonding the polymerizable compounds to alkenyl groups of the liquid crystal molecules used as the diluting agent.

To achieve the above object, the present invention provides the liquid crystal medium of the liquid crystal panel that includes at least one liquid crystal compound based on the tetracene derivative, at least one polymerizable compound, at least one liquid crystal compound based on alkenyl group and main liquid crystal molecules, and the liquid crystal medium is filled in a liquid crystal layer of the liquid crystal panel, in which:
the liquid crystal compound based on the tetracene derivative is shown as a formula (I):

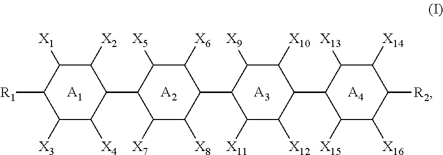

and in the formula (I), A₁ to A₄ are respectively benzene or cyclohexane; X₁ to X₁₆ are respectively a hydrogen atom, a fluorine atom or a chlorine atom; and R₁ and R₂ are respectively alkyl group of 1 to 10 carbon atoms, alkyl group having —O— group, alkyl group having —CH═CH— group, alkyl group having —CO— group, alkyl group having —COO— group, alkyl group having at least one fluorine atom or alkyl group having at least one chlorine atom;
the polymerizable compound is shown as a formula (II):

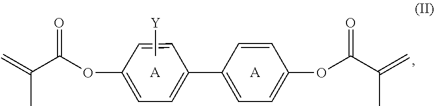

and in the formula (II), A represents benzene; O represents an oxygen atom; and Y
represents a hydrogen atom or a fluorine atom; and the liquid crystal compound based on alkenyl group is shown as a formula (III) or (IV):

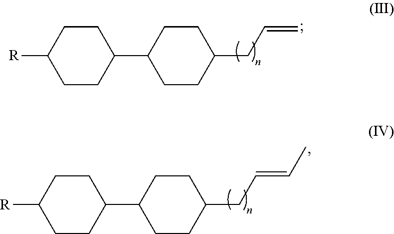

and in the formulas (III) and (IV), R is alkyl group of 1 to 10 carbon atoms, alkyl group having —O— group, alkyl group having —CH═CH— group, alkyl group having —CO— group, alkyl group having —COO— group, alkyl group having at least one fluorine atom or alkyl group having at least one chlorine atom; and n represents an integer of 1 to 5.

In one exemplary embodiment of the present invention, a weight ratio of the liquid crystal compound based on the tetracene derivative is less than 1/20 of the weight ratio of the main liquid crystal molecules.

In one exemplary embodiment of the present invention, the liquid crystal medium is applied to the liquid crystal panel having a patterned vertical alignment mode or a high vertical alignment mode.

In one exemplary embodiment of the present invention, the liquid crystal compound based on alkenyl group is a liquid crystal molecule used as a diluting agent for a vertical alignment mode LCD, and the liquid crystal molecule used as the diluting agent has at least one side chain having double bonds.

Furthermore, the present invention further provides a liquid crystal medium of a liquid crystal panel that includes at least one liquid crystal compound based on the tetracene derivative, at least one polymerizable compound, at least one liquid crystal compound based on alkenyl group and main liquid crystal molecules, and the liquid crystal medium is filled in the liquid crystal layer of the liquid crystal panel, in which:

the liquid crystal compound based on the tetracene derivative is shown as a formula (I):

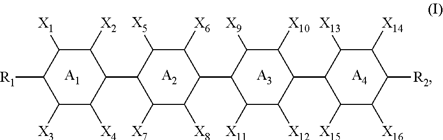

and in the formula (I), A₁ to A₄ are respectively benzene or cyclohexane; X₁ to X₁₆ are respectively a hydrogen atom, a fluorine atom or a chlorine atom; and R₁ and R₂ are respectively alkyl group of 1 to 10 carbon atoms, alkyl group having —O— group, alkyl group having —CH═CH— group, alkyl group having —CO— group, alkyl group having —COO— group, alkyl group having at least one fluorine atom or alkyl group having at least one chlorine atom; and
the polymerizable compound is shown as a formula (II):

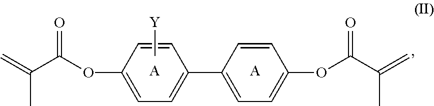

and in the formula (II) A represents benzene; O represents an oxygen atom; and Y represents a hydrogen atom or a fluorine atom.

In one exemplary embodiment of the present invention, a weight ratio of the liquid crystal compound based on the tetracene derivative is less than 1/20 of the weight ratio of the main liquid crystal molecules.

In one exemplary embodiment of the present invention, the liquid crystal medium is applied to the liquid crystal panel having a patterned vertical alignment mode or a high vertical alignment mode.

In one exemplary embodiment of the present invention, the liquid crystal compound based on alkenyl group is a liquid crystal molecule used as a diluting agent for a vertical alignment mode LCD, and the liquid crystal molecule used as the diluting agent has at least one side chain having double bonds.

Furthermore, the present invention also provides a liquid crystal medium of a liquid crystal panel that includes at least one liquid crystal compound based on the tetracene derivative, at least one polymerizable compound, at least one liquid crystal compound based on alkenyl group and main liquid crystal molecules, and the liquid crystal medium is filled in the liquid crystal layer of the liquid crystal panel, in which:

the liquid crystal compound based on the tetracene derivative is shown as a formula (I):

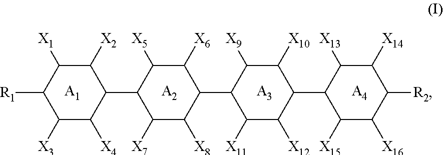

and in the formula (I), A₁ to A₄ are respectively benzene or cyclohexane; X₁ to X₁₆ are respectively a hydrogen atom, a fluorine atom or a chlorine atom; and R₁ and R₂ are respectively alkyl group of 1 to 10 carbon atoms, alkyl group having —O— group, alkyl group having —CH═CH— group, alkyl group having —CO— group, alkyl group having —COO— group, alkyl group having at least one fluorine atom or alkyl group having at least one chlorine atom; and
the liquid crystal compound based on alkenyl group is shown as a formula (III) or (IV):

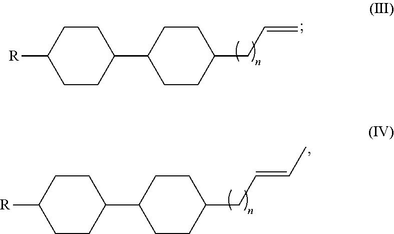

and in the formulas (III) and (IV), R is alkyl group of 1 to 10 carbon atoms, alkyl group having —O— group, alkyl group having —CH═CH— group, alkyl group having —CO— group, alkyl group having —COO— group, alkyl group having at least one fluorine atom or alkyl group having at least one chlorine atom; and n represents an integer of 1 to 5.

In one exemplary embodiment of the present invention, a weight ratio of the liquid crystal compound based on the tetracene derivative is less than 1/20 of the weight ratio of the main liquid crystal molecules.

In one exemplary embodiment of the present invention, the liquid crystal medium is applied to the liquid crystal panel having a patterned vertical alignment mode or a high vertical alignment mode.

In one exemplary embodiment of the present invention, the liquid crystal compound based on alkenyl group is a liquid crystal molecule used as a diluting agent for a vertical alignment mode LCD, and the liquid crystal molecule used as the diluting agent has at least one side chain having double bonds.

The present invention has obvious advantages and beneficial effects than the prior art. The liquid crystal medium of the liquid crystal panel of the present invention has at least the following advantages and beneficial effects by above technical scheme: The liquid crystal compounds based on the tetracene derivative are bonded to alkenyl groups of the liquid crystal molecules used as the diluting agent by doping the liquid crystal compounds based on the tetracene derivative into the liquid crystal mixture, for preventing the reaction between alkenyl groups of the liquid crystal molecules used as the diluting agent and the polymerizable compounds. Thereby, the bond (i.e. linkage) between alkenyl groups of the liquid crystal molecules used as the diluting agent and the polymerizable compounds is inhibited, and thus the problem of image sticking produced via bonding the polymerizable compounds to alkenyl groups of the liquid crystal molecules used as the diluting agent can be improved.

### BRIEF DESCRIPTION OF THE DRAWINGS

FIG. 1 is a schematic view of a structure of a liquid crystal panel containing a liquid crystal medium according to an embodiment of the present invention.

### DETAILED DESCRIPTION OF THE PREFERRED EMBODIMENTS

Various preferred embodiments are now described with reference to the accompanying drawings. In the following description, for purposes of explanation, numerous specific details are set forth in order to provide a thorough understanding of a liquid crystal medium of a liquid crystal panel, and its specific embodiment, structure, feature and functions.

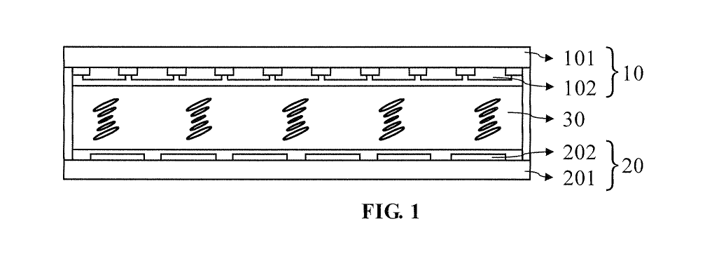

Please refer to FIG. 1, a schematic view of a structure of a liquid crystal panel containing a liquid crystal medium according to an embodiment of the present invention is illustrated. The liquid crystal panel includes a first substrate 10, a second substrate 20 and a liquid crystal layer 30. The first substrate 10 and the second substrate 20 are correspondingly arranged and opposite to each other, and the liquid crystal layer 30 is sandwiched between the first substrate 10 and the second substrate 20. The first substrate 10 can be a color filter (CF) substrate, which includes a first transparent substrate 101 and a color filter layer 102. The color filter layer 102 is disposed on an inner surface of the first transparent substrate 101. The second substrate 20 can be a thin film transistor (TFT) array substrate, which includes a second transparent substrate 201 and a TFT array layer 202. The TFT array layer 202 is disposed on an inner surface of the second transparent substrate 201. The liquid crystal medium within the liquid crystal layer 30 includes main liquid crystal molecules and at least one liquid crystal molecules used as a diluting agent (i.e., a liquid crystal compound based on alkenyl group) of applying to a vertical alignment mode LCD, at least one polymerizable compound and at least one liquid crystal compound based on a tetracene derivative of the present invention. The liquid crystal medium is applied to the liquid crystal panel having a patterned vertical alignment mode or a high vertical alignment mode. The liquid crystal molecule used as the diluting agent has at least one side chain having double bonds.

In the present invention, the liquid crystal compounds based on the tetracene derivative is bonded to pi-bonds (π-bond) of alkenyl groups of the liquid crystal molecules used as the diluting agent by doping the liquid crystal compounds based on the tetracene derivative into a liquid crystal mixture, for preventing a reaction between the pi-bonds of alkenyl groups of the liquid crystal molecules used as the diluting agent and methacrylate radicals of polymerizable compounds, thereby inhibiting a bond between alkenyl groups of the liquid crystal molecules used as the diluting agent and the polymerizable compounds. The liquid crystal mixture includes the main liquid crystal molecules and the liquid crystal molecules used as the diluting agent of applying to the vertical alignment mode LCD, and the polymerizable compounds.

The liquid crystal compound based on the tetracene derivative of the liquid crystal layer 30 of the present invention will now be discussed in further detail hereinafter. The liquid crystal compound based on the tetracene derivative is shown as a formula (I) below:

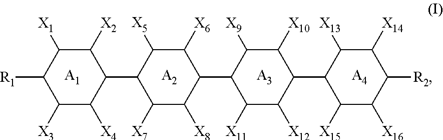

and in the formula (I), A₁ to A₄ are respectively benzene or cyclohexane; X₁ to X₁₆ are respectively a hydrogen atom or a polar atom such as a fluorine atom or a chlorine atom; and R₁ and R₂ are respectively alkyl group of 1 to 10 carbon atoms, alkyl group having —O— group, alkyl group having —CH═CH— group, alkyl group having —CO— group, alkyl group having —COO— group, alkyl group having at least one fluorine atom or alkyl group having at least one chlorine atom. A weight ratio of the liquid crystal compound based on the tetracene derivative is less than 1/20 of the weight ratio of the main liquid crystal molecules (e.g., 1/25, 3/100, 1/50, or 1/100, etc.).

The liquid crystal compound based on the tetracene derivative preferably is constructed by four benzene rings, that is shown as a formula (V) below:

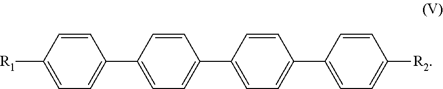

In addition to the liquid crystal compound based on the tetracene derivative, the liquid crystal layer 30 of the present invention further includes the main liquid crystal molecules, the polymerizable compounds having a formula (II) below, and the liquid crystal molecules used as the diluting agent (i.e., the liquid crystal compound based on alkenyl group) having formula (III) or (IV) below. The liquid crystal compound based on the tetracene derivative, the main liquid crystal molecules, the polymerizable compounds and the liquid crystal molecules used as the diluting agent form the liquid crystal medium. The polymerizable compounds are used to distribute the liquid crystal medium onto a polyimide surface of an alignment film.

The polymerizable compounds having the formula (II) are shown, as follows:

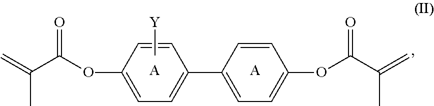

and in the formula (II), A represents benzene; O represents an oxygen atom; and Y represents a hydrogen atom or a fluorine atom.

The liquid crystal molecules used as the diluting agent having the formulas (III) and (IV) are shown, as follows:

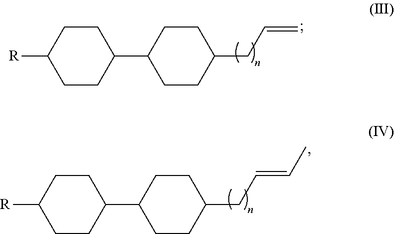

and in the formulas (III) and (IV), R is alkyl group of 1 to 10 carbon atoms, alkyl group having —O— group, alkyl group having —CH═CH— group, alkyl group having —CO— group, alkyl group having —COO— group, alkyl group having at least one fluorine atom or alkyl group having at least one chlorine atom; and n represents an integer of 1 to 5.

As above-mentioned, the liquid crystal compounds based on the tetracene derivative of the present invention are bonded to alkenyl groups of the liquid crystal molecules used as the diluting agent by doping the liquid crystal compounds based on the tetracene derivative into the liquid crystal mixture, for preventing the reaction between alkenyl groups of the liquid crystal molecules used as the diluting agent and the polymerizable compounds. Thereby, the bond between alkenyl groups of the liquid crystal molecules used as the diluting agent and the polymerizable compounds is inhibited, and thus the problem of image sticking produced via bonding the polymerizable compounds to alkenyl groups of the liquid crystal molecules used as the diluting agent can be improved.

The above description of the invention is intended to be illustrative and not limiting. Various changes or modifications in the embodiments described may occur to those skilled in the art. These can be achieved without departing from the spirit or scope of the invention.

What is claimed is:

1. A liquid crystal medium of a liquid crystal panel, comprising at least one liquid crystal compound based on a tetracene derivative, at least one polymerizable compound, at least one liquid crystal compound based on alkenyl group and main liquid crystal molecules, the liquid crystal medium being filled in a liquid crystal layer of the liquid crystal panel, wherein:
the liquid crystal compound based on the tetracene derivative is shown as a formula (I): 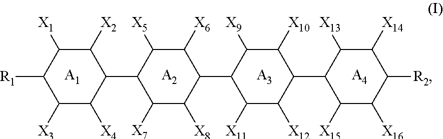
wherein A₁ to A₄ are respectively benzene or cyclohexane; X₁ to X₁₆ are respectively a hydrogen atom, a fluorine atom or a chlorine atom; and R₁ and R₂ are respectively alkyl group of 1 to 10 carbon atoms, alkyl group having —O— group, alkyl group having —CH═CH— group, alkyl group having —CO— group, alkyl group having —COO— group, alkyl group having at least one fluorine atom or alkyl group having at least one chlorine atom;
the polymerizable compound is shown as a formula (II) 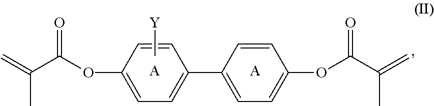
wherein A represents benzene; O represents an oxygen atom; and Y represents a hydrogen atom or a fluorine atom; and
the liquid crystal compound based on alkenyl group is shown as a formula (III) or (IV): 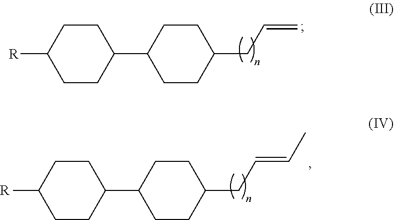
wherein R is alkyl group of 1 to 10 carbon atoms, alkyl group having —O— group, alkyl group having —CH═CH— group, alkyl group having —CO— group, alkyl group having —COO— group, alkyl group having at least one fluorine atom or alkyl group having at least one chlorine atom; and n represents an integer of 1 to 5.

2. The liquid crystal medium of the liquid crystal panel of claim 1, wherein a weight ratio of the liquid crystal compound based on the tetracene derivative is less than 1/20 of the weight ratio of the main liquid crystal molecules.

3. The liquid crystal medium of the liquid crystal panel of claim 1, wherein the liquid crystal medium is applied to the liquid crystal panel having a patterned vertical alignment mode or a high vertical alignment mode.

4. The liquid crystal medium of the liquid crystal panel of claim 1, wherein the liquid crystal compound based on alkenyl group is a liquid crystal molecule used as a diluting agent for a vertical alignment mode liquid crystal display, and the liquid crystal molecule used as the diluting agent has at least one side chain having double bonds.

5. A liquid crystal medium of a liquid crystal panel, comprising at least one liquid crystal compound based on a tetracene derivative, at least one polymerizable compound, at least one liquid crystal compound based on alkenyl group and main liquid crystal molecules, the liquid crystal medium being filled in a liquid crystal layer of the liquid crystal panel, wherein:
the liquid crystal compound based on the tetracene derivative is shown as a formula (I): 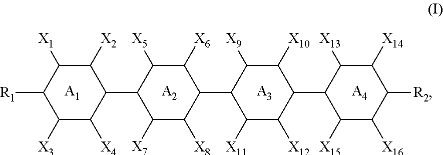
wherein A₁ to A₄ are respectively benzene or cyclohexane; X₁ to X₁₆ are respectively a hydrogen atom, a fluorine atom or a chlorine atom; and R₁ and R₂ are respectively alkyl group of 1 to 10 carbon atoms, alkyl group having —O— group, alkyl group having —CH═CH— group, alkyl group having —CO— group, alkyl group having —COO— group, alkyl group having at least one fluorine atom or alkyl group having at least one chlorine atom; and
the polymerizable compound is shown as a formula (II) 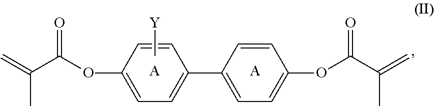
wherein A represents benzene; O represents an oxygen atom; and Y represents a hydrogen atom or a fluorine atom.

6. The liquid crystal medium of the liquid crystal panel of claim 5, wherein a weight ratio of the liquid crystal compound based on the tetracene derivative is less than 1/20 of the weight ratio of the main liquid crystal molecules.

7. The liquid crystal medium of the liquid crystal panel of claim 5, wherein the liquid crystal medium is applied to the liquid crystal panel having a patterned vertical alignment mode or a high vertical alignment mode.

8. The liquid crystal medium of the liquid crystal panel of claim 5, wherein the liquid crystal compound based on alkenyl group is a liquid crystal molecule used as a diluting agent for a vertical alignment mode liquid crystal display, and the liquid crystal molecule used as the diluting agent has at least one side chain having double bonds.

9. A liquid crystal medium of a liquid crystal panel, comprising at least one liquid crystal compound based on a tetracene derivative, at least one polymerizable compound, at least one liquid crystal compound based on alkenyl group and main liquid crystal molecules, the liquid crystal medium being filled in a liquid crystal layer of the liquid crystal panel, wherein:
the liquid crystal compound based on the tetracene derivative is shown as a formula (I): 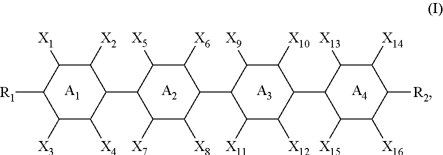
wherein A₁ to A₄ are respectively benzene or cyclohexane; X₁ to X₁₆ are respectively a hydrogen atom, a fluorine atom or a chlorine atom; and R₁ and R₂ are respectively alkyl group of 1 to 10 carbon atoms, alkyl group having —O— group, alkyl group having —CH═CH— group, alkyl group having —CO— group, alkyl group having —COO— group, alkyl group having at least one fluorine atom or alkyl group having at least one chlorine atom; and
the liquid crystal compound based on alkenyl group is shown as a formula (III) or (IV): 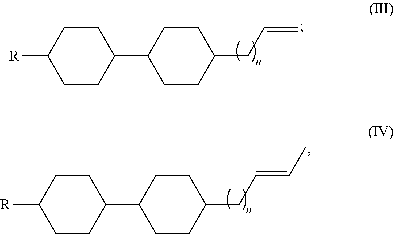
wherein R is alkyl group of 1 to 10 carbon atoms, alkyl group having —O— group, alkyl group having —CH═CH— group, alkyl group having —CO— group, alkyl group having —COO— group, alkyl group having at least one fluorine atom or alkyl group having at least one chlorine atom; and n represents an integer of 1 to 5.

10. The liquid crystal medium of the liquid crystal panel of claim 9, wherein a weight ratio of the liquid crystal compound based on the tetracene derivative is less than 1/20 of the weight ratio of the main liquid crystal molecules.

11. The liquid crystal medium of the liquid crystal panel of claim 9, wherein the liquid crystal medium is applied to the liquid crystal panel having a patterned vertical alignment mode or a high vertical alignment mode.

12. The liquid crystal medium of the liquid crystal panel of claim 9, wherein the liquid crystal compound based on alkenyl group is a liquid crystal molecule used as a diluting agent for a vertical alignment mode liquid crystal display, and the liquid crystal molecule used as the diluting agent has at least one side chain having double bonds.
